(19) United States
(12) Patent Application Publication
(10) Pub. No.: US 2015/0312623 A1
(43) Pub. Date: Oct. 29, 2015

(54) VIDEO CONTROL-PLANE GATEWAY DEVICE

(71) Applicant: Broadcom Corporation, Irvine, CA (US)

(72) Inventors: Yong LI, San Diego, CA (US); Xuemin CHEN, Rancho Santa Fe, CA (US)

(21) Appl. No.: 14/696,312

(22) Filed: Apr. 24, 2015

Related U.S. Application Data
(60) Provisional application No. 61/984,689, filed on Apr. 25, 2014.

(51) Int. Cl. H04N 21/4363; H04N 21/61; H04N 21/6587; H04N 21/435; H04N 21/81; H04N 21/643; H04N 21/21; H04N 21/258

(52) U.S. Cl. CPC H04N 21/43637; H04N 21/21; H04N 21/6156; H04N 21/25816; H04N 21/435; H04N 21/812; H04N 21/643; H04N 21/6587

(57) ABSTRACT

A video control-plane gateway device includes at least one processor circuit. The at least one processor circuit is configured to establish a local connection with a video client device. The at least one processor circuit is configured to receive, over the local connection, a request for a video stream from the video client device. The at least one processor circuit is configured to transmit the request to a network video server via a wireless access point. The at least one processor circuit is configured to receive, from the wireless access point, control information for reception of the video stream on a downlink channel. The at least one processor circuit is configured to transmit, over the local connection, the control information to the video client device. In one or more implementations, the downlink channel is a supplementary downlink channel that is associated with a primary downlink channel through carrier aggregation.

### CROSS-REFERENCE TO RELATED APPLICATIONS

The present application claims the benefit of U.S. Provisional Patent Application Ser. No. 61/984,689, entitled “Video Control-Plane Gateway,” filed on Apr. 25, 2014, which is hereby incorporated by reference in its entirety for all purposes.

### TECHNICAL FIELD

The present description relates generally to a gateway device and also relates to a video control-plane gateway device.

### BACKGROUND

Cellular communication systems, such as long-term evolution (LTE) communication systems, use licensed spectrum bands for wireless transmission. However, the licensed bands may be limited in terms of total available bandwidth, and additional licensed bands may be expensive to obtain. Thus, with the dramatic increase of cellular data traffic, including LTE data traffic, the available licensed spectrum resources may become constrained. In order to increase the spectrum available for cellular data traffic, some have suggested utilizing the 5 Gigahertz (GHz) unlicensed band (that may be used for Wi-Fi data traffic) for cellular data traffic, e.g. LTE-U (unlicensed).

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a video control-plane gateway device may be implemented in accordance with one or more implementations.

FIG. 2 illustrates an example video control-plane gateway device in an example network environment in accordance with one or more implementations.

FIG. 3 illustrates an example video client device in an example network environment in accordance with one or more implementations.

FIG. 4 illustrates a flow diagram of an example process of a video control-plane gateway device in accordance with one or more implementations.

FIG. 5 illustrates a flow diagram of an example process of a video client device in accordance with one or more implementations.

FIG. 6 conceptually illustrates an example electronic system with which one or more implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

The subject video control-plane gateway device allows a video client device that is not serviced by a mobile network operator, but can access cellular transmissions in certain frequency bands (e.g. unlicensed frequency bands), to receive video streams, e.g. from a network video server, via the accessible frequency bands. In particular, the subject system allows a video client device that is not serviced by a mobile network operator to securely pair with a video control-plane gateway device that is serviced by the mobile network operator, such as via a local Bluetooth or Wi-Fi connection. The video client device transmits requests for video streams via the local connection to the video control-plane gateway device. The video control-plane gateway device facilitates configuring the transmission of a requested video stream on a supplementary downlink channel transmitted by a wireless access point associated with the mobile network operator. The supplementary downlink channel may be associated with a primary downlink channel of the video control-plane gateway device through carrier aggregation. In one or more implementations, the primary downlink channel is on a frequency band that is licensed by the mobile network operator and the supplementary downlink channel is on an unlicensed frequency band.

The video control-plane gateway device transmits control information for accessing the video stream on the supplementary downlink channel to the video client device via the local connection. The video client device can then receive the supplementary downlink channel, and access and display the video stream. While displaying the video stream, the video client device transmits video control commands to the video control-plane gateway device via the local connection. The video control-plane gateway device converts the video control commands to remote video control commands, and transmits the remote video control commands on an uplink channel to the wireless access point for transmission to the network video server. Thus, the video client device can receive the requested video stream from the wireless access point of the mobile network, e.g. on an unlicensed frequency band, without having full access to the mobile network and/or without being serviced by the mobile network operator.

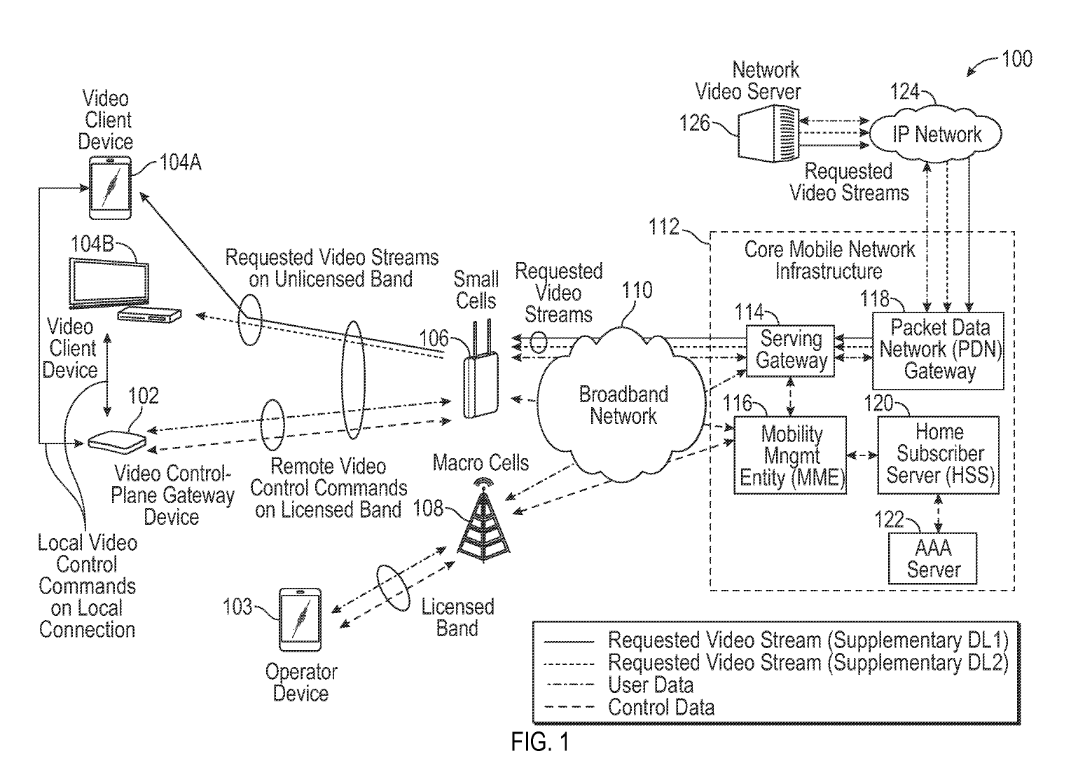

FIG. 1 illustrates an example network environment 100 in which a video control-plane gateway device 102 may be implemented in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

The example network environment 100 includes a video control-plane gateway device 102, a mobile device 103, one or more video client devices 104A-B, one or more small cell access points 106, one or more macrocell access points 108, a broadband network 110, a core mobile network infrastructure 112, an internet protocol (IP) network 124, such as the Internet, and a network video server 126. For explanatory purposes, the example network environment 100 is described in the context of a cellular network; however, the subject system is not limited to cellular networks and is also applicable to, for example, coaxial networks, such as Multimedia over Coax Alliance (MoCA) networks, power line networks, Wi-Fi networks, and other networks that utilize a shared network medium.

The core mobile network infrastructure 112 is associated with a mobile network operator that services the devices 102, 103, e.g. via the access points 106, 108, but does not service the video client devices 104A-B. The core mobile network infrastructure 112 includes a serving gateway 114, a mobility management entity (MME) 116, a packet data network (PDN) gateway 118, a home subscriber server (HSS) 120, and an authentication, authorization, and accounting (AAA) server 122.

The video control-plane gateway device 102, and the mobile device 103, access the IP network 124, and/or services coupled thereto, such as the network video server 126 and/or an IP multimedia subsystem, via the access points 106, 108, the broadband network 110, and the core mobile network infrastructure 112. The mobile device 103 can access downlink transmissions of the macrocell access point 108 using a licensed frequency band, while the video control-plane gateway device 102 can access downlink transmissions of the small cell access point 106 using both a licensed frequency band and an unlicensed frequency band, such as a 5 GHz LTE-U frequency band.

For example, the small cell access point 106 can perform carrier aggregation (CA) across the licensed and unlicensed bands with a first component carrier (CC) on a licensed band, e.g. 2.1 GHz, carrying the primary downlink and control channels, and a second component carrier on an unlicensed band, e.g. 5 GHz, carrying a supplementary downlink channel. In one or more implementations, the primary downlink channel is used for voice and QoS-sensitive data while the supplementary downlink channel is used for best effort data. The video control-plane gateway device 102, and/or the mobile device 103, may establish uplink and control channels on a licensed frequency band, such as 1.7 GHz; however, in one or more implementations, the video control-plane gateway device 102 and/or the mobile device 103 may establish an uplink and/or control channel on an unlicensed frequency band.

The access points 106, 108 may also be referred to as base stations, and the small cell access point 106 may be a femtocell, microcell, or picocell access point. The access points 106, 108 are coupled to the core mobile network infrastructure 112 via the broadband network 110, which may include one or more network devices, such as switch devices, router devices, etc., and/or may utilize one or more network technologies, such as coaxial networking, e.g. implementing the Data Over Cable Service Interface Specification (DOCSIS), fiber optic networking, digital subscriber line (DSL) networking, and the like.

In the core mobile network infrastructure 112, the serving gateway 114 terminates the user data planes of the macrocells and small cells, while the MME 116 terminates the control planes of the macrocells and small cells. The HSS 120 provides service control and a user database for the mobile network, while the AAA server 122 performs authentication, authorization, and accounting for the mobile network. The PDN gateway 118 is an interface to the external IP network 124, and services coupled thereto, such as an IP multimedia subsystem that configures media sessions and maintains media-related applications. The network video server 126 provides one or more video streams for transmission, e.g. to the video client devices 104A-B, via the IP network 124, the core mobile network infrastructure 112, the broadband network 110 and the access points 106,108.

The video control-plane gateway device 102 and/or the mobile device 103, may be referred to as user equipment (UE), and may be, and/or may include, a mobile device, such as a smart phone, a tablet device, a computing device, such as a laptop, a network device, such as a router device and/or a switch device, a communications device, such as a card, a dongle, an adapter, a USB device, etc., that is coupled to a computing device, or generally any wirelessly connectable device. The devices 102, 103 may include, for example, a cellular transmitter and a cellular receiver for cellular communications with the access points 106, 108 over licensed and/or unlicensed bands. The devices 102, 103 may be registered with the mobile network operator associated with the core mobile network infrastructure 112, e.g. such that the devices 102, 103 can authenticate and/or establish uplink and downlink channels with the access points 106, 108.

The video client devices 104A-B may be devices that can receive downlink transmissions from the small cell access point 106 using cellular communications, such as LTE, over licensed and/or unlicensed bands, such as a 5 gigahertz (GHz) band, but that are not serviced by the mobile network operator associated with the core mobile network infrastructure 112 and therefore cannot authenticate with the access points 106, 108. In one or more implementations, one or more of the video client devices 104A-B may be referred to as an off-the-shelf client device, and one or more of the video client devices 104A-B may be, and/or may include, a mobile device, such as a smart phone, a tablet device, a computing device, such as a laptop, a display device, such as a television, a set-top box device, and/or any device that can present a video stream. The video client devices 104A-B may also be, and/or may include, a communications device, such as a card, a dongle, an adapter, a USB device, or generally any wirelessly connectable device, that can be coupled to a device that presents a video stream. In the example network environment 100, the video client device 104A is depicted as a tablet device and the video client device 104B is depicted as a set-top box device that is coupled to a display device.

The video client devices 104A-B may include, for example, a cellular receiver for receiving cellular communications from the small cell access point 106, but may not include a cellular transmitter for transmitting cellular communications to the small cell access point 106. The video client devices 104A-B may not be registered with the mobile network operator associated with the core mobile network infrastructure 112, and therefore the video client devices 104A-B may not be able to authenticate and/or establish uplink and downlink channels with the small cell access point 106. In one or more implementations, one or more of the video client devices 104A-B includes a cellular transmitter for licensed and/or unlicensed bands, but may not be authorized to transmit uplink data to the small cell access point 106 because the video client devices 104A-B are not serviced by the mobile network operator. Alternatively and/or in addition, one or more of the video client devices 104A-B includes the cellular transmitter for licensed and/or unlicensed bands, and is authorized to transmit uplink data to the small cell access point 106.

The video control-plane gateway device 102 and one or more of the video client devices 104A-B may establish, and/or communicate with each other via, a local connection, such as a Wi-Fi connection, a Bluetooth connection, a near field communication (NFC) connection, a Zigbee connection, etc. The video control-plane gateway device 102 and the video client devices 104A-B may communicate via a Wi-Fi connection that is facilitated by the small cell access point 106, e.g. when the small cell access point 106 operates as a Wi-Fi access point. However, although the video client devices 104A-B may be able to communicate with the small cell access point 106 via a Wi-Fi connection, the video client devices 104A-B may be unable to receive cellular transmissions from the small cell access point 106 with the necessary service assurance that can be provided over a cellular connection, such as over LTE, without facilitation from the video control-plane gateway device 102.

In operation, one or more of the video client devices 104A-B, such as the video client device 104A, establishes the local connection with the video control-plane gateway device 102, such as via Bluetooth and/or Wi-Fi, and authenticates with the video control-plane gateway device 102 via the local connection. The video control-plane gateway device 102 may communicate with the small cell access point 106 and/or the core mobile network infrastructure 112 to verify that the video control-plane gateway device 102 has been authorized to facilitate the video client device 104A with receiving video streams from the small cell access point 106 on unlicensed bands in conjunction with, e.g. through carrier aggregation, a primary downlink channel of the video control-plane gateway device 102 on a licensed band.

After the local connection has been established, the video client device 104A may transmit a request for a video stream to the video control-plane gateway device 102, such as a video stream provided by the network video server 126. In one or more implementations, the video control-plane gateway device 102 may store a list of features or services that are available to each of the video client devices 104A-B, and/or that each of the video client devices 104A-B is eligible for. Alternatively, or in addition, the video control-plane gateway device 102 may obtain such as list from the core mobile network infrastructure 112. The video control-plane gateway device 102 can then compare one or more features associated with (or indicated by) the request received from the video client device 104A with the features that the video client device 104A is eligible for. If the video client device 104A is eligible for the one or more features associated with the request, then the video control-plane gateway device 102 accepts the request; otherwise, the video control-plane gateway device 102 rejects the request.

If the video control-plane gateway device 102 accepts the request, the video control-plane gateway device 102 configures a supplementary downlink channel from the small cell access point 106 for reception of the requested video stream and configures transmission of the video stream from the network video server 126 to the small cell access point 106. The supplementary downlink channel may facilitate a requested service configuration that is selected by the video client device 104A. Upon configuring the supplementary downlink channel and the transmission of the requested video stream to the small cell access point 106, the video control-plane gateway device 102 provides control information for accessing the supplementary downlink channel to the video client device 104A via the local connection.

The video client device 104A can then receive the video stream via the supplementary downlink channel without needing to access the primary downlink and control channels of the video control-plane gateway device 102. The video client device 104A transmits video control commands to the video control-plane gateway device 102 via the local connection, and the video control-plane gateway device 102 uses its uplink channel to relay the video control commands to the small cell access point 106 for transmission to the core mobile network infrastructure 112, the IP network 124, and ultimately the network video server 126.

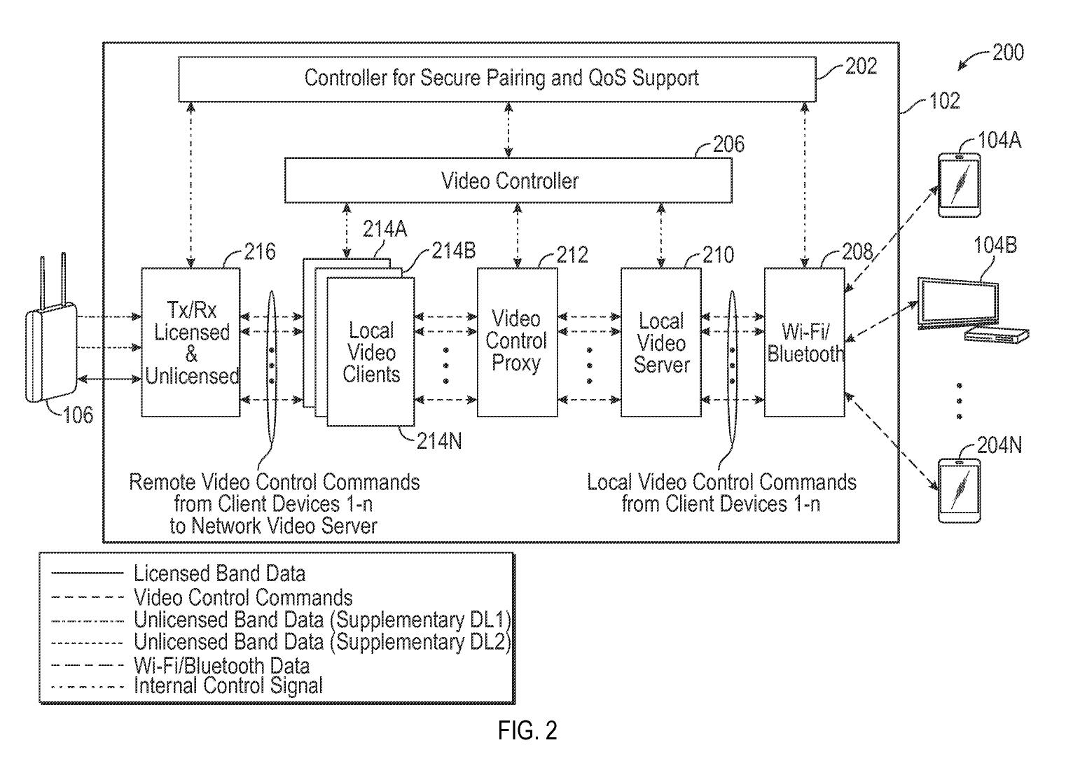

FIG. 2 illustrates an example video control-plane gateway device 102 in an example network environment 200 in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

For explanatory purposes, the video control-plane gateway device 102 is described herein with reference to facilitating the transmission of video streams to the video client devices 104A-B; however, the video control-plane gateway device 102 is not limited to facilitating the transmission of video streams and may also facilitate the transmission of, for example, audio streams or generally any content stream. Furthermore, it will be understood that any transmitted and/or requested video stream may be implicitly associated with an audio stream that is transmitted and/or requested in conjunction and/or coordination with the video stream.

The example network environment 200 includes the video control-plane gateway device 102, the small cell access point 106, and one or more video client devices 102A-B,204N. The video control-plane gateway device 102 includes a controller 202, a cellular communications module 216, local video client modules 214A-N, a video control proxy 212, a local video server 210, and a Wi-Fi/Bluetooth transceiver 208. The cellular communications module 216 includes a licensed frequency band transceiver, and an unlicensed frequency band transceiver. The Wi-Fi/Bluetooth transceiver 208 includes a Wi-Fi/Bluetooth receiver, and a Wi-Fi/Bluetooth transmitter.

In operation, the video control-plane gateway device 102 transmits user and control data to the small cell access point 106 via an uplink channel on a licensed band and the video control-plane gateway device 102 receives user and control data from the small cell access point 106 via a downlink channel on a licensed band. The user and/or control data transmitted on the uplink channel may include video control commands received from one or more of the video client devices 104A-B,204N. The video control-plane gateway device 102 may also receive one or more supplementary downlink channels on unlicensed bands. The supplementary downlink channels may carry video streams requested by the video client devices 104A-B,204N. In one or more implementations, the video control-plane gateway device 102 may not include any video processing capabilities and may act as a control-plane gateway between the video client devices 104A-B,204N and the network video server 126. Thus, in these implementations the video control-plane gateway device 102 may drop and/or ignore the supplementary downlink channels and/or the video streams carried therein.

The video control-plane gateway device 102 may establish a local connection and communicate with one or more of the video client devices 104A-B,204N via the Wi-Fi/Bluetooth transceiver 208. For example, the video control-plane gateway device 102 may transmit Bluetooth low energy (BLE) advertiser messages, and/or beacon signals/messages, via the Wi-Fi/Bluetooth transceiver 208 to advertise that it can facilitate with providing requested video streams on a supplementary downlink channel for the video client devices 104A-B,204N. In response to receiving the advertiser messages, one or more of the video client devices 104A-B,204N may initiate establishing the local connection. The controller 202 provides for secure pairing for the local connection and QoS support.

Upon receiving control information, such as frequency information, timing information, video encoding information, video profile information, encryption keys and/or security keys, from the video control-plane gateway device 102 over the local connection, the video client devices 104A-B,204N may directly receive the supplementary downlink channels and the requested video streams carried therein. In conjunction with a presentation of the video streams, the video client devices 104A-B,204N transmit video control commands, e.g. fast forward, rewind, skip ahead, skip back, etc. to the video control-plane gateway device 102 via the local connection.

The video controller 206 of the video control-plane gateway device 102 coordinates the functions of the local video server 210, the video control proxy 212, and/or the one or more local video client modules 214A-N. The local video server 210 serves the video control commands received from the video client devices 104A-B,204N for the establishment and maintenance (e.g. trick modes) of the requested video streams. The video control proxy 212 converts the video control commands from the video client devices 104A-B,204N to remote video control commands that can be interpreted by the network video server 126. For example, the video control commands received from the video client devices 104A-B,204N may be formatted in accordance with a first specification and/or protocol (or no specification and/or protocol), and the video control proxy 212 may convert the video control commands to a second specification and/or protocol, such as a remote user interface (RUI) protocol.

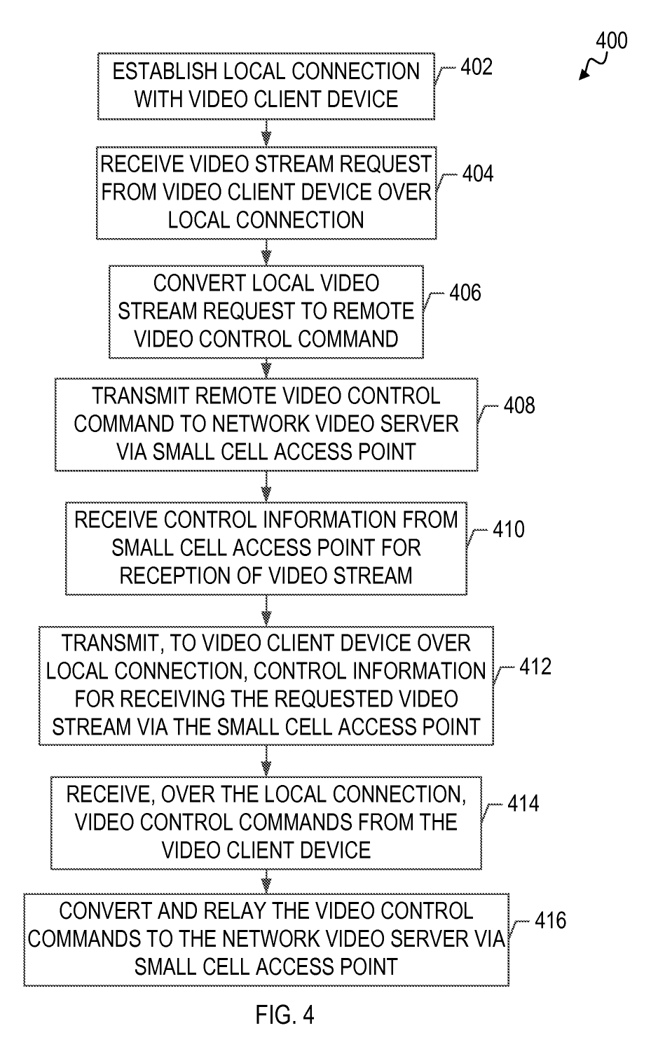

The video control-plane gateway device 102 includes one of the local video client modules 214A-N for each of the active video client devices 104A-B,204N. The local video client modules 214A-N coordinate the transmission of the converted remote video control commands from the corresponding video client devices 104A-B,204N to the network video server 126, e.g. on the uplink from the video control-plane gateway device 102 to the small cell access point 106. Thus, the video control-plane gateway device 102 can serve multiple video client devices 104A-B,204N independently and concurrently, and the video control-plane gateway device 102 handles both the video stream management (including protocol and security keys) as well as the QoS setup for the requested video streams. An example process of the video control-plane gateway device 102 is discussed further below with respect to FIG. 4.

In one or more implementations, one or more of the controller 202, the video controller 206, the Wi-Fi/Bluetooth transceiver 208, the local video server 210, the video control proxy 212, the local video clients 214A-N, and/or the cellular communications module 216 may be implemented in software (e.g., subroutines and code) and/or in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

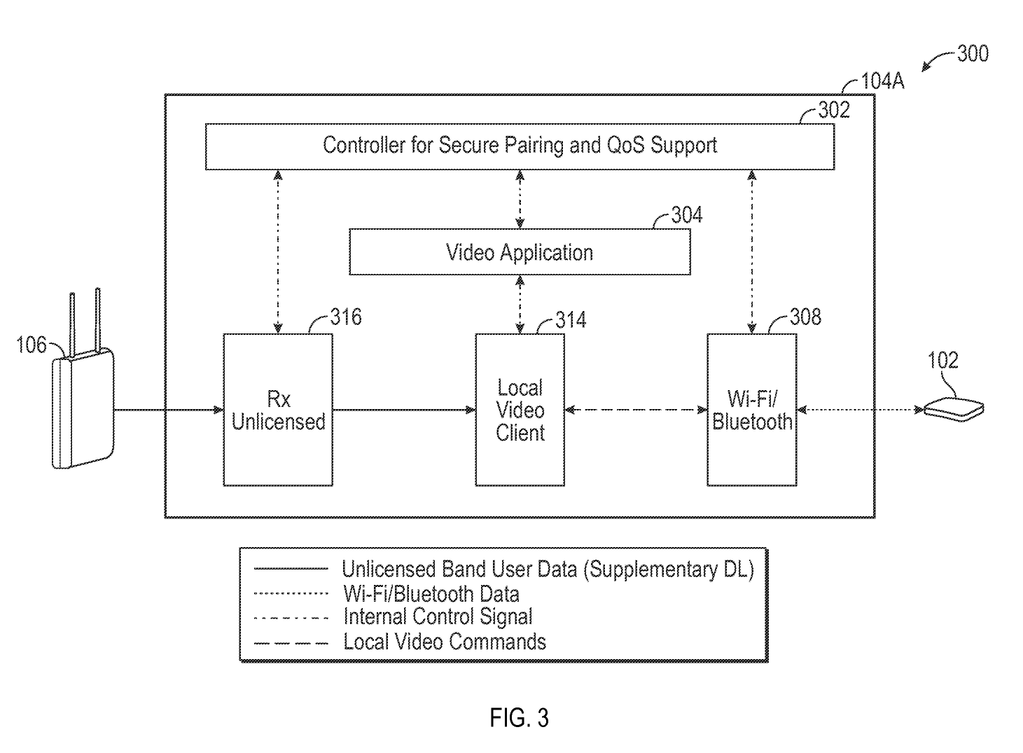

FIG. 3 illustrates an example video client device 104A in an example network environment 300 in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

The example network environment 300 includes the video client device 104A, the video control-plane gateway device 102, and the small cell access point 106. The video client device 104A includes a controller 302, a video application module 304, a Wi-Fi/Bluetooth transceiver 308, a local video client 314, and an unlicensed frequency band receiver 316. The Wi-Fi/Bluetooth transceiver 308 includes a Wi-Fi/Bluetooth receiver, and a Wi-Fi/Bluetooth transmitter. The video application module 304 may be, and/or may include one or more processors and/or one or more processor circuits. In one or more implementations, the video client device 104A further includes a licensed frequency band transmitter and/or an unlicensed frequency band transmitter for transmitting data uplink, such as video uploading, on licensed and/or unlicensed frequency bands.

In operation, the video application module 304 provides an interface, e.g. to a user, for selecting a video stream provided by the network video server 126. In response to the selection of a video stream provided by the network video server 126 (and/or a request for a list of video streams provided by the network video server 126), the video client device 104A establishes a local connection with the video control-plane gateway device 102 via the Wi-Fi/Bluetooth transceiver 308. The controller 202 provides for secure pairing for the local connection and QoS support.

Once the local connection is established, the video client device 104A transmits a request for a video stream to the video control-plane gateway device 102 via the local connection, e.g. using the Wi-Fi/Bluetooth transceiver 308. The video control-plane gateway device 102 coordinates for the transmission of the requested video stream via a supplementary downlink channel transmitted by the small cell access point 106, and transmits control information for accessing the supplementary downlink channel to the video client device 104A via the local connection.

The video client device 104A configures the unlicensed frequency band receiver 316 to receive the supplementary downlink channel based at least in part on the control information, and the received video stream is passed to the local video client 314. The local video client 314 provides the video stream to the video application module 304 for presentation, e.g. to a user. The local video client 314 and/or the video application module 304 may process the video stream, such as decode the video stream, decrypt the video stream, e.g. with an encryption and/or security key received from the video control-plane gateway device 102, and/or generally may perform any video processing on the video stream.

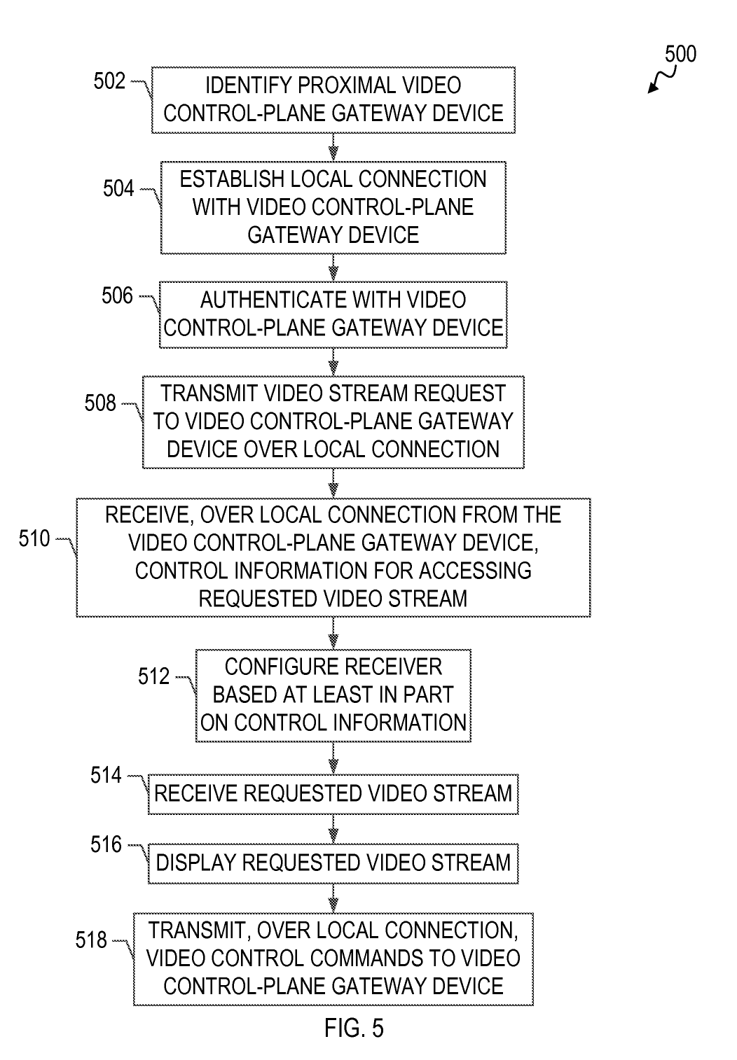

During presentation of the video stream, the video application module 304 receives video control commands, e.g. from a user input device, and passes the video control commands to the local video client 314. The local video client 314 provides the video control commands to the Wi-Fi/Bluetooth transceiver 308 for transmission to the video control-plane gateway device 102, which coordinates relaying the video control commands to the network video server 126. In one or more implementations, the video control commands may include trick mode commands, fast forward commands, rewind commands, skip ahead commands, skip back commands, pause commands, play commands, and the like. An example process of the video client device 104A is discussed further below with respect to FIG. 5.

In one or more implementations, one or more of the controller 302, the video application module 304, the Wi-Fi/Bluetooth transceiver 308, the local video client 314, and/or the unlicensed frequency band receiver 316 may be implemented in software (e.g., subroutines and code) and/or in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

FIG. 4 illustrates a flow diagram of an example process 400 of a video control-plane gateway device in accordance with one or more implementations. For explanatory purposes, the example process 400 is primarily described herein with reference to the video control-plane gateway device 102 of FIGS. 1-3; however, the example process 400 is not limited to the video control-plane gateway device 102 of FIGS. 1-3, e.g. the example process 400 may be performed by other video control-plane gateway devices, and/or the example process 400 may be performed by one or more components of the video control-plane gateway device 102. Further for explanatory purposes, the example process 400 is described as being performed by the video control-plane gateway device 102 for a single video client device 104A; however, the example process 400 may be simultaneously performed by the video control-plane gateway device 102 any number of times for any number of video client devices. Further for explanatory purposes, the blocks of the example process 400 are described herein as occurring in serial, or linearly. However, multiple blocks of the example process 400 may occur in parallel. In addition, the blocks of the example process 400 may be performed a different order than the order shown and/or one or more of the blocks of the example process 400 may not be performed.

The video control-plane gateway device 102 establishes a local connection with a requesting video client device, such as the video client device 104A (402). The video control-plane gateway device 102 may also authenticate the video client device 104A in order to secure the local connection. For example, the video control-plane gateway device 102 may receive a request from the video client device 104A to establish a Bluetooth and/or Wi-Fi connection, and the video control-plane gateway device 102 may establish the local connection (402) in response to the request. The video control-plane gateway device 102 receives a request for a video stream from the video client device 104A over the local connection (404). The requested video stream may be a video stream that is provided by the network video server 126.

In one or more implementations, the video control-plane gateway device 102 may receive, from the video client device 104A over the local connection, a request for a list of video streams provided by the network video server 126. The video control-plane gateway device 102 may retrieve a list of available video streams, e.g. from the network video server 126, and provide the list of available video streams to the video client device 104A over the local connection.

The video control-plane gateway device 102 converts the request for the video stream to a remote video control command, such as an RUI remote video control command (406). The video control-plane gateway device 102 transmits the remote video control command on an uplink to the small cell access point 106 for transmission to the network video server 126 (408). The uplink may be on a licensed frequency band or an unlicensed frequency band. In conjunction with transmitting the remote video control command, the video control-plane gateway device 102 may also coordinate with the small cell access point 106 for the establishment of a supplementary downlink channel, e.g. on an unlicensed frequency band, that the small cell access point 106 will use for transmission of the requested video stream upon receiving the same from the network video server 126.

The video control-plane gateway device 102 receives control information from the small cell access point 106 for the reception of the requested video stream, e.g. via a supplementary downlink channel on an unlicensed band (410). The video control-plane gateway device 102 transmits, to the video client device 104A over the local connection, the control information for receiving the requested video stream via the small cell access point 106, e.g. on the supplementary downlink channel (412). The video client device 104A may then receive the video stream directly from the small cell access point 106 on the supplementary downlink channel.

The video control-plane gateway device 102 receives, over the local connection, video control commands from the video client device 104A (414). The video control-plane gateway device 102 converts the video control commands to remote video control commands and relays the remote video control commands to the network video server 126 via the uplink channel with the small cell access point 106 (416). The network video server 126 modifies the video stream being transmitted to implement the received remote video control commands. Thus, the video stream subsequently transmitted by the small cell access point 106 reflects the implemented remote video control commands.

FIG. 5 illustrates a flow diagram of an example process 500 of a video client device in accordance with one or more implementations. For explanatory purposes, the example process 500 is primarily described herein with reference to the video client device 104A of FIGS. 1-3; however, the example process 500 is not limited to the video client device 104A of FIGS. 1-3, e.g. the example process 500 may be performed by the video client device 104B of FIGS. 1 and 2, or other video client devices, and/or the example process 500 may be performed by one or more components of the video client device 104A. Further for explanatory purposes, the blocks of the example process 500 are described herein as occurring in serial, or linearly. However, multiple blocks of the example process 500 may occur in parallel. In addition, the blocks of the example process 500 may be performed a different order than the order shown and/or one or more of the blocks of the example process 500 may not be performed.

The video client device 104A identifies a video control-plane gateway device (502), such as the video control-plane gateway device 102. For example, the video client device 104A may discover the video control-plane gateway device 102 via one or more discovery protocols, such as Bluetooth discovery protocols, BLE discovery protocols, Wi-Fi Direct discovery protocols, or other discovery protocols. The video client device 104A establishes a local connection with the video control-plane gateway device 102, such as via the Wi-Fi/Bluetooth transceiver 308 (504). The local connection can be point-to-point (e.g. Bluetooth, Wi-Fi Direct, etc.) and/or the local connection can be facilitated by a local controller (e.g. a Wi-Fi access point). In one or more implementations, the video application module 304 of the video client device 104A triggers the video client device 104A to identify and establish the local connection with the video control-plane gateway device 102.

The video client device 104A authenticates itself to the video control-plane gateway device 102 by running an authentication process over the local connection (506). In one or more implementations, the authentication process can be based on public-key cryptography, and/or a shared secret between the devices 102, 104A. Upon successful authentication, a secure channel is established between the two devices 102, 104A via the local connection.

Once a secure channel is established between the two devices 102, 104A, the video client device 104A transmits a request for a video stream, e.g. a video stream provided by the network video server 126, to the control-plane gateway device 102 over the local connection (508). The video control-plane gateway device 102 may then coordinate the transmission of the requested video stream from the network video server 126 to the small cell access point 106. The video control-plane gateway device 102 may also coordinate, with the small cell access point 106, the provisioning of a supplementary downlink channel on an unlicensed band, such as LTE-U, where the supplementary downlink channel is in carrier aggregation with a primary downlink channel of the video control-plane gateway device 102.

The video client device 104A receives, from the video control-plane gateway device 102 over the local connection, control information for accessing the requested stream, e.g. via the supplementary downlink channel from the small cell access point 106 (510). The control information may include, for example, frequency information, such as an assigned frequency, timing information, such as assigned timeslot, synchronization information, or generally any information that may be used to receive the supplementary downlink channel from the small cell access point 106. The control information may also include information for decoding and/or decrypting the video stream once received, such as video encoding information, one or more security and/or encryption keys for decrypting the video stream, and the like.

The video client device 104A uses the control information to configure the unlicensed frequency band receiver 316 to receive the supplementary downlink channel from the small cell access point 106 (512). The video client device 104A then receives the requested video stream through the supplementary downlink channel transmitted by the small cell access point 106 (514). The video client device 104A displays or presents the received video stream on a display device, e.g. to a user (516). The video client device 104A receives video control commands, e.g. from a user interface device, in connection with the display of video stream, and transmits the video control commands to the video control-plane gateway device 102 via the local connection for transmission to the network video server 126 (518).

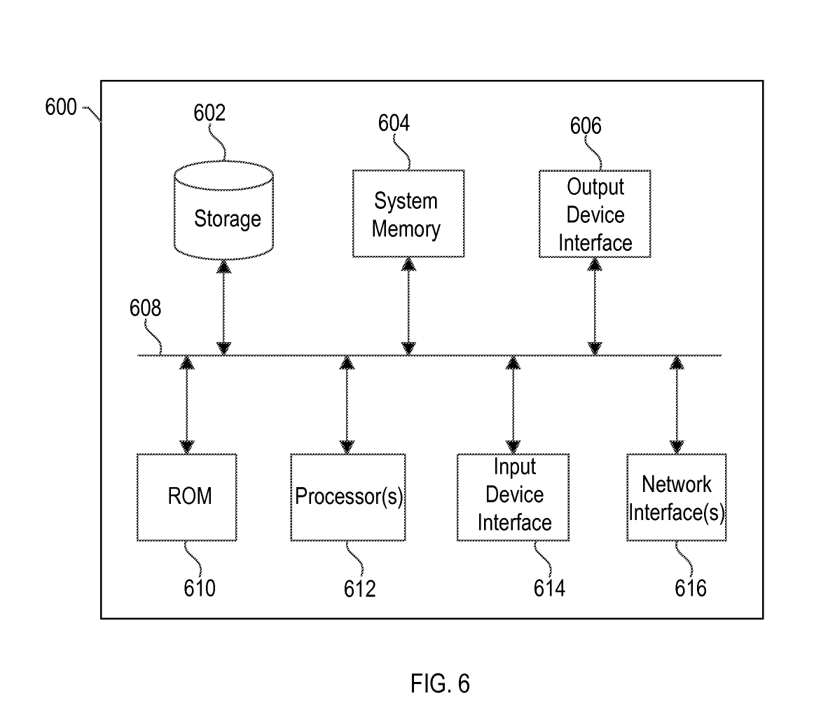

FIG. 6 conceptually illustrates an example electronic system 600 with which one or more implementations of the subject technology can be implemented. The electronic system 600, for example, may be, and/or may include, one or more of the video control-plane gateway device 102, the mobile device 103, the video client devices 104A-BG, the small cell access point 106, the macrocell access point 108, the serving gateway 114, the MME 116, the PDN 118, the HSS 120, the AAA server 122, the network video server 126, one or more wearable devices, a desktop computer, a laptop computer, a tablet device, a phone, and/or generally any electronic device. Such an electronic system 600 includes various types of computer readable media and interfaces for various other types of computer readable media. The electronic system 600 includes a bus 608, one or more processing unit(s) 612, a system memory 604, a read-only memory (ROM) 610, a permanent storage device 602, an input device interface 614, an output device interface 606, one or more network interface(s) 616, and/or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are utilized by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a floppy disk, flash drive, and its corresponding disk drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory (RAM). The system memory 604 may store one or more of the instructions and/or data that the one or more processing unit(s) 612 may utilize at runtime. In one or more implementations, the processes of the subject disclosure are stored in the system memory 604, the permanent storage device 602, and/or the ROM 610. From these various memory units, the one or more processing unit(s) 612 retrieve instructions to execute and data to process in order to execute the processes of one or more implementations.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by the electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

As shown in FIG. 6, bus 608 also couples electronic system 600 to one or more networks (not shown) through one or more network interface(s) 616. The one or more network interface(s) may include one or more of a Bluetooth interface, a Bluetooth low energy (BLE) interface, a Zigbee interface, an Ethernet interface, a Wi-Fi interface, a MoCA interface, a power line interface, a reduced gigabit media independent interface (RGMII), a cellular interface for communicating over licensed bands, a cellular interface for communicating over unlicensed bands, and/or generally any interface for connecting to a network. In this manner, electronic system 600 can be a part of one or more networks of computers, such as a telecommunications or cellular network, a local area network (LAN), a personal area network (PAN), a peer-to-peer network (P2P), a wide area network (WAN), an Intranet, or a network of networks, such as the Internet. Any or all components of electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, SSD, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “access point”, “receiver”, “computer”, “server”, “processor”, and “memory” all refer to electronic or other technological devices. These terms exclude people or groups of people. For the purposes of the specification, the terms “display” or “displaying” means displaying on or by an electronic device.

As used herein, the phrase “at least one of” preceding a series of items, with the term “and” or “or” to separate any of the items, modifies the list as a whole, rather than each member of the list (e.g., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device comprising:
at least one processor circuit configured to:
establish a local connection with a video client device;
receive, over the local connection, a request for a video stream from the video client device;
transmit the request to a network video server via a wireless access point;
receive, from the wireless access point, control information for reception of the video stream on a downlink channel; and
transmit, over the local connection, the control information to the video client device.

2. The device of claim 1, wherein the wireless access point comprises a small cell access point associated with a mobile network operator that services the device.

3. The device of claim 2, wherein the downlink channel comprises a supplementary downlink channel that is associated through carrier aggregation with a primary downlink channel, both provisioned for the device by the small cell access point associated with the mobile network operator.

4. The device of claim 3, wherein the primary downlink channel is on a frequency band licensed to the mobile network operator and the supplementary downlink channel is on an unlicensed frequency band.

5. The device of claim 4, wherein the at least one processor circuit is further configured to:
transmit the request from the video client device to wireless access point on an uplink channel; and
receive, from the wireless access point on the primary downlink channel, the control information for the reception of the video stream on the supplementary downlink channel.

6. The device of claim 5, wherein the video client device is not serviced by the mobile network operator.

7. The device of claim 1, wherein the at least one processor circuit is further configured to:
receive, over the local connection from the video client device, video control commands associated with the video stream;
convert the video control commands to remote video control commands; and
relay the remote video control commands to the network video server via the wireless access point.

8. The device of claim 7, wherein the video control commands comprise at least one trick mode command.

9. The device of claim 1, wherein the at least one processor circuit is further configured to:
authenticate the device over the local connection.

10. The device of claim 1, wherein the local connection comprises at least one of a Bluetooth connection, a Wi-Fi connection, or a near field communication (NFC) connection.

11. The device of claim 1, wherein the control information comprises at least one of frequency information, timing information, security information associated with the reception of the video stream, or video encoding information associated with the video stream.

12. The device of claim 1, wherein the at least one processor circuit is further configured to:
convert the request from the video client device to a remote video control command; and
transmit the remote video control command to the network video server via the wireless access point.

13. A method comprising:
establishing a local connection with a device that is serviced by a network operator;
transmitting, to the device over the local connection, a request for a video stream;
receiving, from the device over the local connection, control information for accessing the video stream on a downlink channel provisioned for the device by an access point associated with the network operator; and
receiving the video stream on the downlink channel.

14. The method of claim 13, further comprising:
configuring a receiver to receive the video stream on the downlink channel based at least in part on the control information.

15. The method of claim 13, further comprising:
displaying the video stream on a display device;
receiving video control commands in connection with the display of the video stream; and
transmitting, to the device over the local connection, the video control commands.

16. The method of claim 13, further comprising:
receiving an advertiser message from the device; and
establishing the local connection in response to the advertiser message.

17. The method of claim 13, wherein the control information comprises at least one of frequency information, timing information, or a security key for decrypting the video stream.

18. A computer program product comprising instructions stored in a tangible computer-readable storage medium, the instructions comprising:
instructions to establish an uplink channel and a primary downlink channel with an access point associated with a network operator, and to establish a local connection with a video client device;
instructions to receive, over the local connection, a first request for a video stream from the video client device, wherein the video client device is not serviced by the network operator;
instructions to transmit, on the uplink channel to the access point, a second request for establishment of a supplementary downlink channel that is associated with the primary downlink channel through carrier aggregation, and for transmission of the video stream on the supplementary downlink channel;
instructions to receive, on the primary downlink channel, control information for reception of the supplementary downlink channel on which the access point will transmit the video stream; and
instructions to transmit, over the local connection to the video client device, the control information for the reception of the supplementary downlink channel on which the access point will transmit the video stream.

19. The computer program product of claim 18, the instructions further comprising:
instructions to receive, over the local connection from the video client device, video control commands;
instructions to convert the video control commands to remote video control commands; and
instructions to transmit the remote video control commands on the uplink channel to the access point for transmission to a network video server associated with the video stream.

20. The computer program product of claim 18, wherein the primary downlink channel is on a frequency band licensed by the network operator and the supplementary downlink channel is on an unlicensed frequency band.
